(19) United States
(12) Patent Application Publication
(10) Pub. No.: US 2024/0355612 A1
(43) Pub. Date: Oct. 24, 2024

(54) An Improved Ion Guide Bandpass Filter

(71) Applicant: DH Technologies Development Pte. Ltd., Singapore (SG)

(72) Inventors: David M. COX, Toronto (CA); Manuel FAUR, Toronto (CA); Mircea GUNA, Toronto (CA); Yang KANG, Richmond Hill (CA); Andrei SONOC, Richmond Hill (CA)

(21) Appl. No.: 18/685,356

(22) PCT Filed: Aug. 23, 2022
(86) PCT No.: PCT/IB2022/057893

§ 371 Date: Feb. 21, 2024

Related U.S. Application Data
(60) Provisional application No. 63/236,389, filed on Aug. 24, 2021.

(51) Int. Cl. H01J 49/42; H01J 49/00

(52) U.S. Cl. CPC H01J 49/4215; H01J 49/004

(57) ABSTRACT

In one aspect, an ion filter for use in a mass spectrometer is disclosed, which includes a plurality of rods arranged in a multipole configuration to provide a passageway through which ions can travel, said plurality of rods being configured for application of RF voltages thereto to provide an electromagnetic field within the passageway for providing radial confinement of the ions and further configured for application of a DC voltage thereto. At least two pairs of auxiliary electrodes are interspersed between the plurality of rods and are configured for application of a DC bias voltage with one polarity to one of said pairs and a DC bias voltage with an opposite polarity to the other one of said pairs to provide a DC potential difference between the auxiliary electrodes and the plurality of rods.

### RELATED APPLICATIONS

The present application claims priority to a provisional application entitled AN IMPROVED ION GUIDE BANDPASS FILTER having application No. 63/236,389 filed on Aug. 24, 2021 which is incorporated by reference herein in its entirety.

### TECHNICAL FIELD

The present disclosure relates generally to ion mass filters for use in mass spectrometric systems.

### BACKGROUND

The present teachings are generally related to an ion mass filter for use in mass spectrometric systems, and more particularly to methods and systems that can compensate for mechanical misalignments and/or electrical imbalances in such an ion mass filter.

Ion filters are employed in a variety of mass spectrometers for selecting ions having m/z ratios within a range of interest. By way of example, U.S. Pat. No. 10,741,378 titled “RF/DC Filter to Enhance Mass Spectrometer Robustness” discloses an ion mass filter that includes a plurality of rods arranged in a multipole configuration to which RF voltages are applied and a plurality of auxiliary electrodes interposed between the multipole rods to which DC voltages are applied such that the combination of RF and DC voltages allows manipulation of the transmission of the ions through the ion mass filter.

### SUMMARY

In one aspect, an ion mass filter for use in a mass spectrometer is disclosed, which includes a plurality of rods arranged in a multipole configuration to provide a passageway through which ions can travel, said plurality of rods being configured for application of RF voltages thereto to provide an electromagnetic field within the passageway for providing radial confinement of the ions and further configured for application of a DC voltage thereto. At least two pairs of auxiliary electrodes (each pair is herein referred to also as a pole) are interspersed between the plurality of rods and are configured for application of DC bias voltages thereto.

The auxiliary DC bias voltage applied to each pair includes a DC filtering voltage component and a DC corrective voltage component. The polarity of the DC filtering voltage component applied to one pair of the auxiliary electrodes is opposite to the polarity of the DC filtering voltage component applied to the other pair of the auxiliary electrodes. Further, the DC filtering components of the voltages applied to said two pairs of auxiliary electrodes are configured to provide stable trajectories for ions with m/z ratios in a target range and unstable trajectories for ions with m/z ratios outside that target range and the DC corrective components are configured to provide a substantial compensation for misalignment of at least one of said plurality of rods and said auxiliary electrodes relative to at least another one of said plurality of rods and said auxiliary electrodes. The misalignment can be an axial and/or a radial misalignment, that is, a misalignment along a longitudinal axis of the ion filter (axial misalignment) and/or a misalignment along a direction that is perpendicular to that longitudinal axis (radial misalignment).

While the polarity of the DC filtering component applied to one pole of the auxiliary electrodes is opposite to the polarity of the DC filtering component applied to the other pole of the auxiliary electrodes, the polarity of the DC corrective component applied to one pole of the auxiliary electrodes can be the same as or opposite to the polarity of the DC corrective component applied to the other pole of the auxiliary electrodes.

The DC corrective components can be configured to minimize, and preferably prevent, trapping of ions with m/z ratios in the target range within the ion mass filter. By way of example, in some embodiments, each of the DC corrective components can be in a range of about −5% to about 5% of a respective DC filtering component.

In some embodiments, the RF voltages applied to the multipole rods are configured (e.g., their frequency and/or amplitude are selected) to filter low-mass ions, e.g., to filter ions with m/z ratios less than a first threshold. In some such embodiments, the DC voltages applied to the auxiliary electrodes and the DC voltage applied to the plurality of rods are configured to generate an electric field distribution within the ion passageway of the ion filter that can cause filtering of ions having m/z ratios above a second threshold such that the combination of the RF voltages applied to the multipole rods and the DC voltages applied to the multipole rods as well as the auxiliary electrodes can provide a bandpass ion mass filter, e.g., a bandpass ion mass filter that would allow the passage of ions having m/z ratios between said first and said second thresholds.

In some embodiments, the auxiliary electrodes can include a plurality of T-shaped electrodes. In some such embodiments, the T-shaped electrodes can include a backplate (e.g., a square-shaped backplate) from which a stem can radially extend toward a longitudinal axis associated with the plurality of multipole rods.

In some embodiments, the multipole rods include four rods that are arranged in a quadrupole configuration. The present teachings are not, however, limited to a plurality of rods that are arranged in a quadrupole configuration, rather other multipole configurations, such as an octupole configuration, may also be employed.

In some embodiments, the auxiliary electrodes can have substantially the same length as the multipole rods while in other embodiments the lengths of the multipole rods and the auxiliary electrodes can be different. For example, the auxiliary electrodes can be shorter than the multipole rods. By way of example, and without limitation, the length of the auxiliary electrodes can be about ⅓, ¼, or ⅕ of the length of the auxiliary electrodes.

In some embodiments, the at least two pairs of the auxiliary electrodes include four auxiliary electrodes, each of which is interposed between two of the plurality of rods.

In some embodiments, the RF voltages applied to the multipole rods can have a frequency in a range of about 0.1 MHz to about 5 MHz, e.g., in a range of about 1 MHz to about 3 MHz, or in a range of about 3 MHz to about 5 MHz. In some such embodiments, the RF voltages can have an amplitude in a range of about 10 volts to about 5 kilovolts (V₀₋ₚ), e.g., in a range of about 100 to 2000 V₀₋ₚ, or in a range of about 2000 to 5000 V₀₋ₚ. In some embodiments, the DC bias voltages applied to the auxiliary electrodes have an amplitude in a range of about −8500 volts to about +8500 volts, e.g. in a range of about −1000 V to about +1000 V, in a range of about −3000 V to +3000 V, or in a range of about −7000 V to +7000 V.

In a related aspect, a mass spectrometer is disclosed, which includes an ion filter having a plurality of rods that are arranged in a multipole configuration to provide a passageway through which ions can travel, said plurality of rods being configured for application of RF voltages thereto to provide an electromagnetic field within said passageway for providing radial confinement of the ions and further configured for application of a DC voltage thereto. The ion mass filter can further include at least two pairs of auxiliary electrodes interspersed between said plurality of rods and configured for application of DC bias voltages to the auxiliary electrodes to provide a potential difference between the plurality of rods and the auxiliary electrodes.

The DC bias voltage applied to each pair (each pole) of the auxiliary electrodes includes a DC filtering component and a DC corrective component, where the DC filtering components of the voltages applied to said two pairs of auxiliary electrodes are configured to provide stable trajectories for ions with m/z ratios in a target range and unstable trajectories for ions with m/z ratios outside that target range and the DC corrective components are configured to provide a substantial compensation for misalignment of at least one of the plurality of rods and the auxiliary electrodes relative to at least another one of the plurality of rods and the auxiliary electrodes.

The mass spectrometer can further include at least one RF voltage source for applying RF voltage(s) to the plurality of the multipole rods and at least one DC voltage source for applying DC voltages to the plurality of rods and the auxiliary electrodes. In some such embodiments, the at least one DC voltage source can include two independent DC voltage sources, where one of the DC voltage sources is configured to apply the DC voltage(s) to the multipole rods and the other DC voltage source is configured to apply the DC voltages to the auxiliary electrodes.

As noted above, the polarity of the filtering component of the DC voltage applied to one pair of the auxiliary electrodes can be opposite to the polarity of the respective filtering component of the DC voltage applied to another pair of the auxiliary electrodes so as to generate a desired electric field distribution within the passageway through which the ions travel from an inlet of the ion filter to its outlet.

In a related aspect, a method for tuning an ion filter incorporated in an MS/MS mass spectrometer is disclosed, where the ion filter includes a plurality of rods arranged in a multipole configuration to provide a passageway for transit of ions therethrough and is configured for application of RF voltages thereto. The ion mass filter further includes at least two pairs of auxiliary electrodes dispersed between the rods and configured for application of DC bias voltages thereto so as to generate a DC potential difference between the auxiliary electrodes and the multipole rods. The polarity of DC bias voltage applied to one pair of the auxiliary electrodes (i.e., one pole of the auxiliary electrodes) is opposite to the polarity of the DC bias voltage applied to another pair of the auxiliary electrodes (i.e., another pole of the auxiliary electrodes). In embodiments, the voltage differential between the voltages applied to the two poles of the auxiliary electrodes can be adjusted (e.g., via application of corrective voltages to those electrodes) so as to substantially compensate for mechanical misalignments and/or DC voltage imbalances.

One example of the method can include the following steps: (a) using the MS/MS mass spectrometer to acquire a first measurement of an MRM transition of a precursor ion with no DC bias voltages applied to the auxiliary electrodes (voltage applied on auxiliary electrodes is identical to rod DC offsets), (b) using the MS/MS mass spectrometer to acquire a second measurement of the MRM transition of the precursor ion with DC voltages applied to the auxiliary electrodes to provide a target ion transmission bandwidth, (c) estimating a signal loss associated with said ion filter based on a ratio of the intensity of the second measurement relative to the first measurement, and (d) adjusting said DC offset voltages applied to said auxiliary electrodes to reduce said signal loss, and (e) iterating the above steps (a)-(d) so as to minimize the signal loss, i.e., to optimize the performance of the mass spectrometer.

In some embodiments, subsequent to performing the second measurement of the MRM transition, the application of DC voltages to the auxiliary electrodes is terminated and another (a third) measurement of the MRM transition is performed. A ratio of the intensity of the third MRM measurement relative to the intensity of the second MRM measurement is indicative of cross-talk between the two MRM measurements. For example, when DC bias voltages are applied to the auxiliary electrodes and mechanical misalignment on electrodes or rods results in trapping of at least a portion of the ions, subsequent to switching off the DC voltages, at least a portion of the trapped ions can be released from the ion mass filter and can be detected, thereby increasing the intensity of the detected MRM transition. In embodiments, the tuning can achieve an optimal, or a range of optimal DC offset voltages, for application to the auxiliary electrodes for minimizing cross-talk and thus compensating for effects of misalignment.

Further understanding of various aspects of the present teachings can be obtained by reference to the following detailed description in conjunction with the associated drawings, which are described briefly below.

### BRIEF DESCRIPTION OF THE DRAWINGS

FIG. 1A is a cross-sectional view of an ion filter along its longitudinal axis, where the ion filter includes four rods arranged in a quadrupole configuration and four T-shaped auxiliary electrodes each of which is interposed between two of the quadrupole rods,

FIG. 1B is another schematic view of the ion filter depicted in FIG. 1A,

FIG. 2 shows simulated DC potential traces obtained for an ion filter having a structure shown in FIG. 1 with and without (axial) misalignment of the T-shaped auxiliary electrodes,

FIG. 3 schematically depicts an ion filter according to an embodiment of the present teachings,

FIG. 4 is a flow chart illustrating various steps of an embodiment of a method according to the present teachings for tuning an ion filter,

FIG. 5A schematically depicts an example of a mass spectrometer in which an ion filter according to an embodiment of the present teachings is incorporated,

FIG. 5B schematically shows that in some implementations of the mass spectrometer two ion guides, designated as DJet and QJet in this figure, can be used upstream of a mass filter employed in the mass spectrometer,

FIGS. 6A, 6B, and 6C depict simulated DC potential traces in an ion filter according to an embodiment of the present teachings,

FIG. 7A shows the intensities of three measurements of an MRM transition (with a dwell time of 5 ms) using an embodiment of an ion filter according to the present teachings, with no DC bias voltages applied to the T-bar auxiliary electrodes (signal 1), with DC bias voltage (Tbar delta=−683 V), applied to the T-bar auxiliary electrodes (signal 2) followed by no DC bias voltages applied to the T-bar electrodes (signal 3),

FIG. 7B shows the intensity of the same MRM transition as that presented in FIG. 7A with an unbalanced DC offset voltages applied to the two pairs of the auxiliary electrodes to minimize signal intensity loss and cross-talk,

FIG. 8A shows variation of an MRM signal intensity loss and cross talk when the DC voltage applied to the B pole of the auxiliary electrodes of an ion filter according to an embodiment of the present teachings was fixed and the DC voltage applied to the A pole was tuned,

FIG. 8B shows variation of the MRM signal intensity loss and cross talk when the DC voltage applied to the A pole of the auxiliary electrodes of an ion filter was fixed and the DC voltage applied to the B pole was tuned,

FIG. 8C shows variation of the MRM signal intensity loss and cross talk when T-bar offset voltage (i.e., the voltage difference between the DC voltage applied to the T-bar pole and the rod) was adjusted,

FIGS. 9A and 9C show MRM transition intensities corresponding to 6 ions obtained with ion filtering applied in T-bar pole A (9A) and T-bar pole B (9C), under optimized T-bar offsets tuning conditions,

FIG. 9B shows the respective MRM transitions of the 6 ions with no T-bar DC offset correction applied to Pole B, and

FIG. 10 depicts an example of an implementation of a controller suitable for use in the practice of various embodiments according to the present teachings.

### DETAILED DESCRIPTION

It will be appreciated that for clarity, the following discussion will explicate various aspects of embodiments of the present disclosure, while omitting certain specific details wherever convenient or appropriate to do so. For example, discussion of like or analogous features in alternative embodiments may be somewhat abbreviated. Well-known ideas or concepts may also for brevity not be discussed an any great detail. One of ordinary skill will recognize that some embodiments of the present disclosure may not require certain of the specifically described details in every implementation, which are set forth herein only to provide a thorough understanding of the embodiments. Similarly it will be apparent that the described embodiments may be susceptible to alteration or variation according to common general knowledge without departing from the scope of the disclosure. The following detailed description of embodiments is not to be regarded as limiting the scope of the applicant's teachings in any manner.

As used herein, the terms “about” and, “substantially, and “substantially equal” refer to variations in a numerical quantity and/or a complete state or condition that can occur, for example, through measuring or handling procedures in the real world; through inadvertent error in these procedures; through differences in the manufacture, source, or purity of compositions or reagents; and the like. Typically, the terms “about” and “substantially” as used herein means 10% greater or lesser than the value or range of values stated or the complete condition or state. For instance, a concentration value of about 30% or substantially equal to 30% can mean a concentration between 27% and 33%. The terms also refer to variations that would be recognized by one skilled in the art as being equivalent so long as such variations do not encompass known values practiced by the prior art. The above definition of substantially indicates that “substantial compensation” refers to a compensation that had a deviation, if any, from a complete compensation by at most 10%.

As used herein the term “and/or” includes any and all combinations of one or more of the associated listed items and may be abbreviated as “/”.

Various terms are used herein in accordance with their ordinary meanings in the art. For example, the term “mass ion filter” and “ion filter” are used herein interchangeably to refer to a structure that can be employed, for example, in a mass spectrometer, for limiting the transmission of ions to those having a target m/z ratio or an m/z ratio within a target range. The terms “mechanical misalignment” and “misalignment” are used herein interchangeably to refer to deviation of one or more components of an ion mass filter relative to its nominal position (i.e., relative to the intended position). Such a misalignment can occur along a longitudinal direction of the ion mass filter and/or along a radial direction (i.e., a direction perpendicular to the longitudinal direction) of the mass filter.

In the following discussion, a DC voltage applied to a pair of auxiliary electrodes (i.e., a DC voltage applied to a pole of the auxiliary electrodes) can include a DC voltage offset (herein also referred to as a DC potential offset) that is equal to a DC voltage offset applied to the multipole rods (e.g., a DC voltage difference between the multipole rods of a mass filter according to the present teachings and the multipole rods of an ion guide positioned upstream of that mass filter) and a DC bias voltage. In an off state where the auxiliary electrodes do not provide any bandpass filtering, the DC voltage offset applied to both pairs of the auxiliary electrodes are identical to that applied to the multipole rods. The DC bias voltage applied to a pair of the auxiliary electrodes can be in turn considered as being composed of a DC filtering voltage component and a DC corrective voltage component. The DC filtering components applied to different pairs of the auxiliary electrodes correspond to bias voltages that would be applied to the pairs of the auxiliary electrodes in absence of any misalignments such that the difference between the bias voltages applied to different poles (e.g., two different poles) of the auxiliary electrodes will result in a desired mass filtering of ions passing through the mass filter. The corrective components applied to one or both pairs of the auxiliary electrodes provide an adjustment (e.g., of the order of a few percent) of the DC filtering components so as to substantially compensate for misalignments of any of the auxiliary electrodes and/or multipole rods and/or DC voltage imbalances between DC power supplies that supply DC voltages to the auxiliary electrodes.

Previous studies have shown that under ideal conditions, including precise alignment of various elements of an ion mass filter (e.g., when a multipole set of rods of an ion filter are free of misalignment), ion trapping can be reduced, and potentially minimized, via application of bias voltages to various elements (e.g., multipole rods) of the ion filter. However, the inventors have recognized that ion trapping can still exist when mechanical misalignment and/or electrical imbalances are present, e.g., axial and/or radial misalignment between auxiliary electrodes of a mass filter having a plurality of rods arranged in a multipole configuration and a plurality of auxiliary electrodes interspersed between those rods.

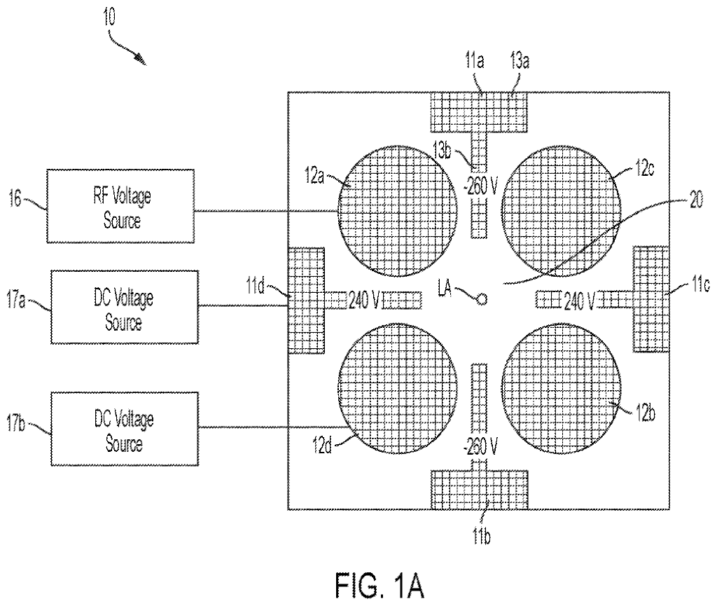

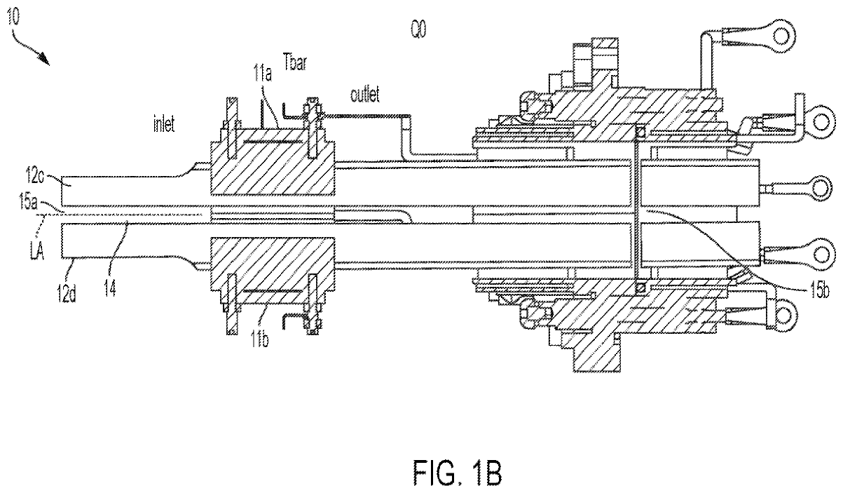

FIGS. 1A and 1B schematically depict a conventional ion mass filter 10 that includes four rods 12a, 12b, 12c, and 12d that are arranged in a quadrupole configuration relative to one another (herein referred to collectively as the quadrupole rods 12). The quadrupole rods 12 are disposed about a central longitudinal axis (LA) and are radially spaced relative to one another to form a passageway 14 therebetween, which extends from an inlet 15a for receiving ions to an outlet 15b through which ions can exit the passageway. An RF voltage source 16 can apply RF voltages to the quadrupole rods so as to generate an electromagnetic field within the passageway for radially confining the ions and causing collisional cooling of the ions before they pass to a downstream mass analyzer.

In this embodiment, the amplitude of the RF voltages applied to the quadrupole rods are substantially the same, but the polarity of the RF voltages applied to one pair of quadrupole rods (12a/12b) is the opposite of the polarity of the RF voltages applied to the other pair of quadrupole rods (12c/12d).

The ion mass filter 10 further includes four T-shaped auxiliary electrodes 11a, 11b, 11c, and 11d (herein collectively referred to as the T-shaped auxiliary electrodes 11), each of which is interposed between two of the quadrupole rods. Each of the T-shaped auxiliary electrodes includes a backplate from which a stem extends toward the longitudinal axis of the passageway (such as the illustrative backplate 13a and stem 13b).

A DC voltage source 17b is operably coupled to the quadrupole rods 12 to apply a DC voltage thereto and another DC voltage source 17a is operably coupled to the T-shaped auxiliary electrodes 11 to apply DC bias voltages to the auxiliary electrodes, where the voltages applied to the T-shaped auxiliary electrodes are different from the DC voltage applied to the quadrupole rods so as to generate a potential difference between the quadrupole rods and the T-shaped auxiliary electrodes, to be used in a bandpass filter mode (on state). The operation can also be in a “transparent mode” where no DC bias voltages are applied (DC bias voltage=0, or off state); in such case, DC potentials applied on auxiliary electrodes are identical to DC potentials on quadrupole rods. Under this condition, the rods/auxiliary electrodes are used as a conventional ion filter with no high mass cutoff created.

As discussed in more detail below, the DC bias voltages applied to the auxiliary electrodes includes a DC filtering component and a DC corrective component. As noted above, in absence of any mechanical misalignments and/or DC voltage imbalances, the corrective component is not present and the voltage differential (ΔV) between the filtering component of the DC voltage applied to one pair relative to the DC voltage offset applied to the multiple rods is positive and a respective voltage differential between the filtering component of the DC voltage applied to the other pair and the multiple rods is negative. The voltage differentials can create a high mass cut-off (HMCO).

In this embodiment, the filtering component of the DC voltage applied to the pair 11a/11b of the auxiliary electrodes has an opposite polarity relative to the filtering component of the DC voltage applied to the other pair 11c/11d of the auxiliary electrodes. In this disclosure, each pair of the auxiliary electrodes to which a voltage with the same polarity is applied is referred to as a pole of the ion filter. The combination of the DC voltages applied to the quadrupole rods 12 and the DC bias voltages applied to the T-shaped auxiliary electrodes 11 generates an octupolar DC field that stabilizes the trajectories of certain ions having m/z ratios within a target range while other ions with m/z ratios outside the target range will experience unstable trajectories.

In some embodiments, the RF voltage applied to the quadrupole rods 12 can filter low mass ions having m/z ratios below a first threshold (e.g., ions having m/z ratios less than about 100) and the DC voltage differential between the auxiliary electrodes generates an electric field distribution within the passageway so as to filter high mass ions having m/z ratios above a second threshold (e.g., ions having m/z ratios greater than about 900). In this manner, the combination of the quadrupole rods and the auxiliary electrodes and the RF and DC voltages applied thereto can provide a bandpass ion filter that allows the passage of ions having m/z ratios between the first and the second thresholds.

The DC bias voltages applied to each pair (each pole) of the T-shaped auxiliary electrodes relative to the multipole rods can be positive or negative. Such polarity of the DC voltage difference between the poles of the auxiliary electrodes and the multipole rods and the polarity of the charge of the ions passing through the filter results in the deposition of unstable ions (or at least a portion thereof) on one of the poles.

In some cases, the DC bias voltages applied to one pair of the T-shaped auxiliary electrodes can be close to the DC voltage applied to the quadrupole rods while the DC voltages applied to the other pair of the T-shaped auxiliary electrodes is sufficiently different from the DC voltage applied to the quadrupole rods such that the resultant DC field will provide the desired filtering function. This approach is referred to as the asymmetrical approach. Alternatively, the DC bias potentials applied to the opposite pairs of the auxiliary electrodes can have substantially the same values, but opposite polarities (an example of which is shown in FIG. 1A). It is known that the symmetrical approach can effectively eliminate ion trapping while the asymmetrical approach can result in substantial ion trapping.

Although the symmetrical approach can effectively eliminate ion trapping, such elimination of ion trapping can be achieved under conditions of precise mechanical alignment of the quadrupole rods and the T-shaped auxiliary electrodes and the precise levels of the DC offset and bias potentials. Inventors have discovered that a small misalignment in the positions of the T-shaped auxiliary electrodes in axial and/or radial directions can result in a potential barrier and/or a potential well that can cause trapping of at least a portion of the ions.

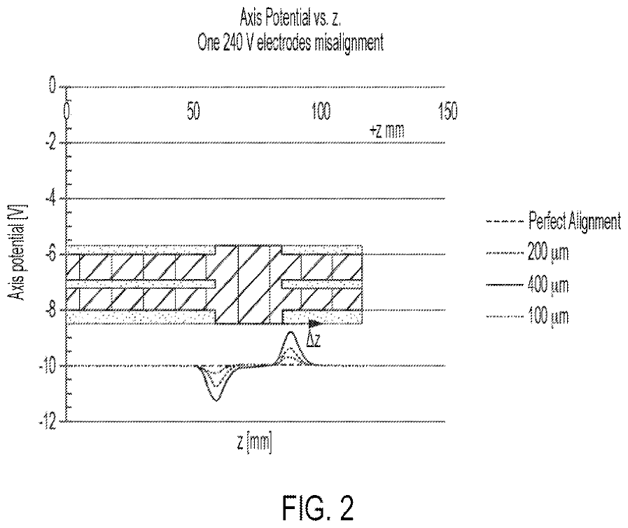

By way of example, as shown in FIG. 2, when one of the T-shaped auxiliary electrodes is axially misaligned by 100 micrometers, a 0.34 volt potential barrier is formed at the entrance of the mass filter and a potential well is formed at the exit of the mass filter. Such a potential barrier and potential well could result in trapping of ions as the ions pass through the mass filter.

The inventors have also observed, via performing a number of experimental observations, a substantial signal loss for multi reaction monitoring (MRM) transition signal of reserpine (m/z 609) at a 5 millisecond dwell time (with a 5 ms pause time) in a mass filter in which the T-shaped auxiliary electrodes were not well aligned (approximately 200 μm shift) when the T-shaped auxiliary electrodes were enabled (via application of bias voltages thereto, i.e., in an on state) to filter out higher m/z ions (>709 Da) relative to a respective MRM transition signal obtained without enabling the T-shaped auxiliary electrodes (bias voltage=0, i.e., in an off state).

Further, an extended (e.g., 20-25 ms) dwell time or pause time in MRM was required to achieve comparable signals between the on and off states of the T-shaped auxiliary electrodes. Consistent with the simulation results, misalignments in the T-shaped auxiliary electrodes and/or the quadrupole rods can cause trapping of at least some of the ions, which can in turn lead to signal loss, especially at fast signal acquisition rates (e.g., at signal acquisition rates faster than about 2-4 ms), as well as an increase in cross-talk, as discussed further below. Such trapping effects can be more pronounced with respect to higher m/z ions.

By way of illustration, FIG. 2 shows simulated DC potential traces with and without misalignments between T-shaped auxiliary electrodes. Table 1 below summarizes simulated front barrier potential generated as a function of several axial misalignment values of one of the T-shaped auxiliary electrodes, indicating that as the misalignment increases so does the front potential barrier.

TABLE 1

| Δz (mm) | Front Barrier (eV) |
|---|---|
| 0.0 | 0 |
| 0.1 | 0.34 |
| 0.2 | 0.62 |
| 0.4 | 1.26 |

One possible approach for minimizing (and preferably eliminating) misalignment of the T-shaped auxiliary electrodes and/or the quadrupole rods is to employ manufacturing techniques that would result in precise alignment of the T-shaped auxiliary electrodes and/or the quadrupole rods. Such manufacturing techniques can be, however, too costly and difficult for commercialization.

Thus, there is a need for an approach for minimizing the effects of slight misalignments, e.g., misalignments in a range of about 5 micrometers (μm) to about 500 μm along the axial and/or about 10 μm to about 500 μm along the radial dimensions of the auxiliary electrodes and/or the multipole rods of an ion mass filter, thereby improving the performance of the ion mass filter without a need for removing the ion filter assembly and realigning the T-shaped auxiliary electrodes and/or the multipole rods. This can also improve the robustness of the T-shaped auxiliary electrodes as well as increase the instrument's uptime.

As discussed in more detail below, in embodiments, corrective DC bias voltages can be applied to the T-bar auxiliary electrodes in a controlled manner to compensate for the misalignment of the T-bar auxiliary electrodes and/or the quadrupole rods. In other words, it has been discovered that in many embodiments the unbalancing of the DC bias voltages applied to the T-bar auxiliary electrodes by small amounts can be utilized as a practical approach to compensate for the misalignments of the T-bar auxiliary electrodes and/or the quadrupole rods.

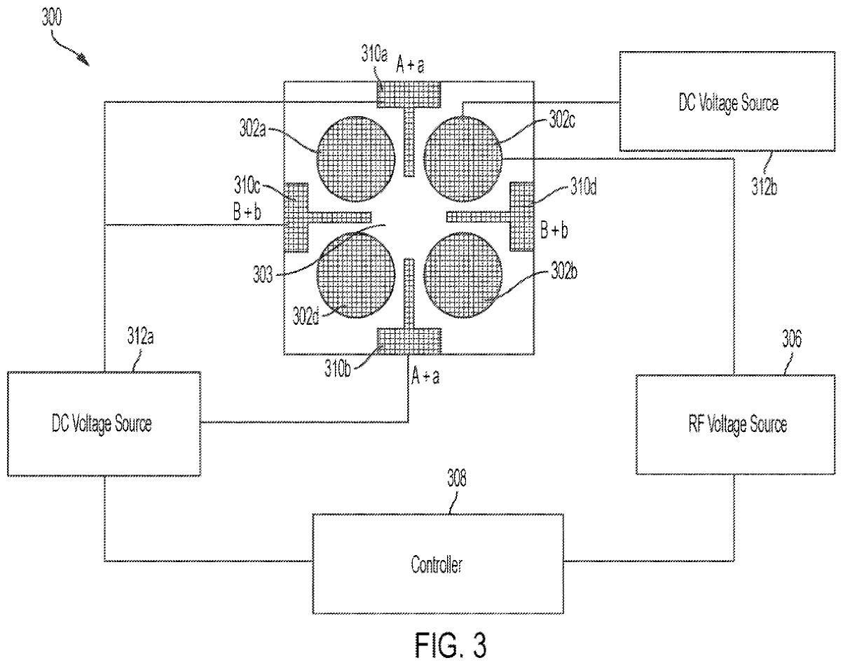

By way of example, FIG. 3 schematically depicts an ion mass filter 300 according to an embodiment of the present teachings. Similar to the above ion mass filter 10, the ion mass filter 300 includes four rods 302a, 302b, 302c, and 302d that are arranged relative to one another in a quadrupole configuration (herein referred to collectively as the quadrupole rods 302) to provide a passageway 303 therebetween, where the passageway extends from an inlet through which ions can enter the passageway to an outlet through which ions can exit the passageway.

An RF voltage source 306 operating under the control of a controller 308 applies RF voltages to the quadrupole rods so as to generate a quadrupolar electromagnetic field within the passageway, which can facilitate the radial confinement of the ions as they pass through the passageway. The ions can also undergo collisional cooling as they pass through the passageway, e.g., via collisions with a background gas. The RF voltages applied to the quadrupole rods can also allow filtering out low mass ions (e.g., ions having m/z ratios less than about 100).

In this embodiment, the RF voltages applied to the rod pairs (302a/302b) and (302c/302d) have substantially the same amplitude but opposite polarities.

The mass filter 300 further includes a plurality of T-shaped auxiliary electrodes 310a, 310b, 310c, and 310d (herein collectively referred to as the T-shaped auxiliary electrodes 310 or T-bar electrodes 310), where each of the T-bar electrodes is interposed between two of the quadrupole electrodes 302. The auxiliary electrodes 310a and 310b form one pole of the auxiliary electrodes (herein referred to as the A-pole) and the auxiliary electrodes 310c and 310d form another pole of the auxiliary electrodes (herein referred to as the B-pole).

A DC voltage source 312b applies a DC voltage to the quadrupole rods and another DC voltage source 312a applies DC voltages to the A-pole and the B-pole of the T-bar auxiliary electrodes. The DC voltages applied to the quadrupole rods and the T-bar auxiliary electrodes result in the generation of an octupolar DC electric field distribution within the passageway that allows for the transmission of ions with m/z ratios within a target range while inhibiting the transmission of ions with m/z ratios outside the target range. In particular, the DC voltage differential between the auxiliary electrodes and the multipole rods can generate a DC field that can destabilize the trajectories of certain ions with m/z ratios higher than a threshold and hence inhibit their transmission through the mass filter. In other words, the electric field generated within the passageway can cause certain ions to experience stable trajectories and hence be transmitted through the passageway while other ions experience unstable trajectories and may be deposited on the T-bar electrodes and/or the quadrupole rods.

As discussed above, the DC electric field distribution can provide a low pass mass filter by inhibiting transmission of ions having m/z ratios above a threshold. Further, as discussed above, the RF field generated as a result of application of RF voltages to the quadrupole rods can generate a high pass mass filter by inhibiting the transmission of low mass ions (e.g., ions having m/z ratios less than about 100) through the ion mass filter. In this manner, a bandpass ion filter can be generated.

In some embodiments, the DC voltage applied to the quadrupole rods can be selected to provide a DC potential offset between the quadrupole rods and an upstream and/or a downstream component of a mass spectrometer in which the ion mass filter 300 is positioned.

In order to correct for misalignment of the T-bar auxiliary electrodes and/or the quadrupole rods, the DC voltages applied to the T-bar auxiliary electrodes can deviate from nominal values that would be applied to those electrodes in absence of any misalignment. Such deviation of the DC voltages from their nominal values can be selected to compensate for misalignment(s) of the T-bar auxiliary electrodes and/or the quadrupole rods so as to minimize, and preferably eliminate, trapping of ions passing through the ion filter.

In other words, the DC voltage applied to each pair of the auxiliary electrodes can be viewed as having two components, namely, a DC filtering component (herein also referred to as a primary component) and a DC corrective component (herein also referred to as a secondary component). The DC filtering component is responsible primarily for providing an electric field distribution that can create a high mass cutoff (HMCO) for inhibiting the transmission of ions having m/z ratios above a threshold.

The DC potentials required to generate a high mass cutoff are related to the stability of ion beams which depend on the radial amplitude of the ions. For example, for a given transmission window width, the DC bias voltage on auxiliary electrodes scales linearly with the RF amplitude on rods.

The DC corrective component can in turn help compensate for an axial and/or radial misalignment of any of the T-bar auxiliary electrodes and/or the quadrupole rods by minimizing, and preferably eliminating, trapping of ions of interest, which could otherwise occur as a result of such misalignment, as the ions pass through the ion filter. By way of illustration, FIG. 3 presents the DC voltages applied to the A-pole of the T-bar auxiliary electrodes as having a DC filtering component (A) and a DC corrective component (a), which can be a fraction of the DC filtering component. Similarly, the DC voltage applied to the B-pole of the T-bar auxiliary electrodes can be represented as having a DC filtering component (B) and a DC corrective component (b), which is a fraction of the DC filtering component.

By way of example, each corrective DC voltage component can be in a range of about −5% to about +5% of the respective DC filtering component. While in some embodiments each corrective component is the same fraction of the respective filtering component, in other embodiments the corrective components can be different fractions of their respective filtering components. The corrective components can be determined based on the degree of misalignment of one or more of the T-bar auxiliary electrodes and/or the quadrupole rods. Further, as noted above, the corrective components applied to the A-pole and the B-pole of the auxiliary electrodes can have the same or opposite polarities.

The determination of the corrective DC bias voltages can be achieved using a variety of different methods, such as manual tuning and/or auto tuning. By way of example, in such tuning methods, percentage changes from nominal voltages applied to the T-bar electrodes (i.e., voltages in absence of corrective components, that is, voltages that can be applied in absence of any mechanical misalignment) can be set at values that minimize (and preferably eliminate) the trapping of ions within the ion mass filter.

By way of example, the determination of the corrective DC bias voltages can be achieved by observing one or more mass signals and measuring signal loss or cross-talk under different deviations from the nominal DC voltages (e.g., under different values of a and b corrective voltages) and/or different T-bar and/or multipole rod offsets relative to upstream or downstream components of a mass spectrometer in which the ion filter is incorporated so as to arrive at optimal values for the deviations from the nominal DC voltages.

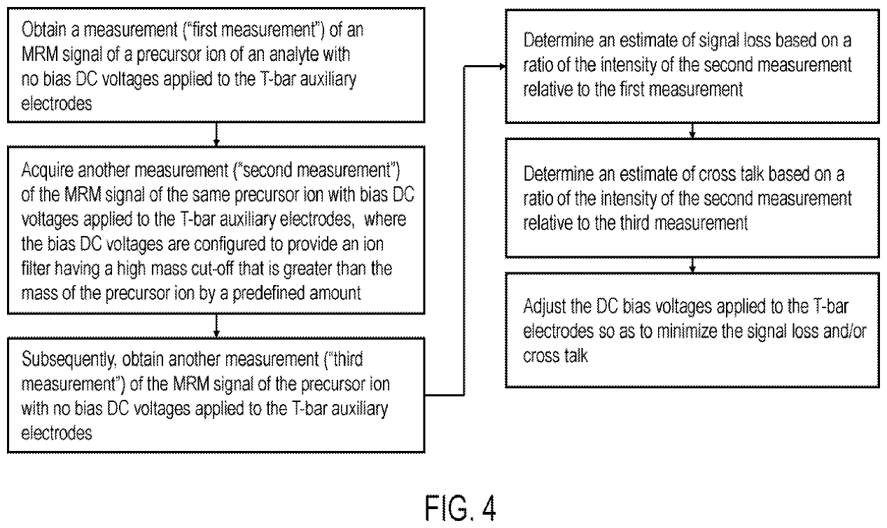

By way of example, with reference to the flow chart of FIG. 4, in one embodiment, three consecutive short (e.g., 5 ms dwell time) MRM signals associated with the same precursor ion can be acquired in three experiments and corrective DC voltages can be determined based on the relative intensities of the MRM signals. For example, an MRM signal (herein referred to as the first MRM signal) of a precursor ion associated with a target analyte can be acquired with no DC bias voltages applied to the T-bar auxiliary electrodes.

Subsequently, another MRM signal (herein referred to as the second MRM signal) of the same precursor ion can be acquired with DC bias voltages applied to the T-bar electrodes so as to create a high mass cutoff (HMCO) with a mass cutoff that is higher by a certain amount (e.g., 50 Da or 100 Da) than the mass of the precursor ion. Finally, another MRM signal can be acquired with no bias voltages applied to the T-bar electrodes, that is, the same as first MRM. The ratio of the signal intensity associated with the second MRM signal relative to the signal intensity associated with the first MRM signal can be used to determine signal loss while the intensity ratio associated with the second MRM signal relative to that associated with the third MRM signal can be used to determine cross talk. During the measurements, the DC bias voltages applied to the T-bar electrodes can be adjusted so as to minimize any of the signal loss and/or cross-talk.

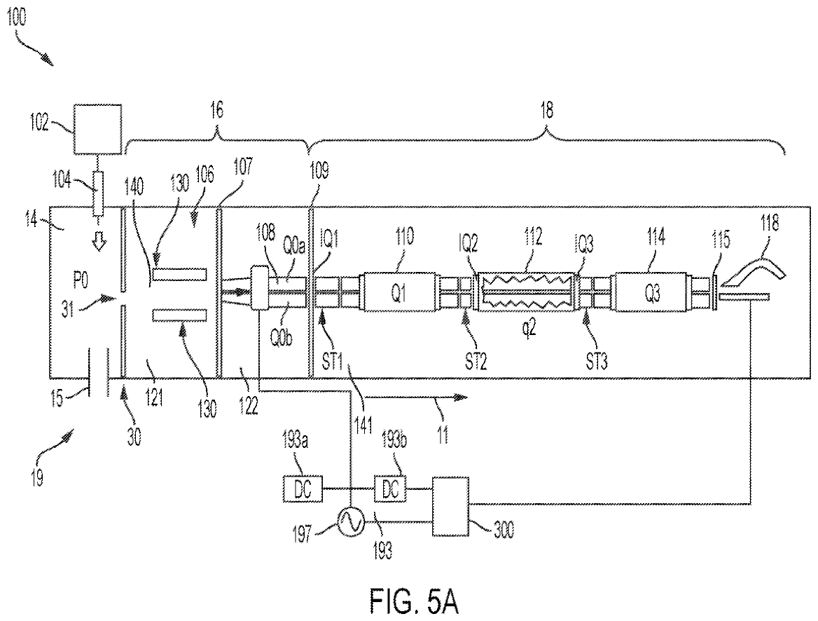

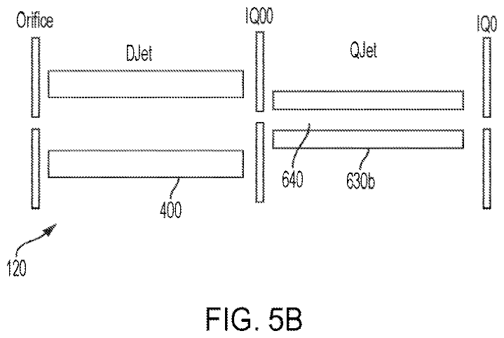

With reference to FIGS. 5A and 5B, a mass spectrometer 100 according to an embodiment of the present teachings includes an ion source 104 that receives a sample from a sample source 102 to generate a plurality of ions that are introduced into a chamber 14, which is evacuated via a port 15. At least a portion of the ions pass through an orifice 31 of an orifice plate 30 into a chamber 121 in which an ion guide 140 (herein also referred to as Qjet) is disposed.

The chamber 121 can be maintained, for example, at a pressure in a range of about 1 Torr to about 10 Torr. The QJet ion guide includes four rods (two of which 130 are visible in the figure) that are arranged according to a quadrupole configuration to provide a passageway therebetween through which the ions can pass through the ion guide. RF voltages can be applied to the rods of the QJet ion guide, e.g., via capacitive coupling to a downstream ion guide Q0 discussed further below or via an independent RF voltages source, for radially confining, and focusing the ions for transmission to a downstream chamber 122 in which an ion filter 108 according to an embodiment of the present teachings is disposed. An ion lens 107 to which a DC voltage is applied separates the vacuum chamber 122 from the vacuum chamber 121 and helps focus the ions exiting the vacuum chamber 106 into the vacuum chamber 108.

The chamber 122 can be maintained at a pressure lower than the pressure at which the chamber 121 is maintained. By way of example, the chamber 122 can be operated at a pressure in a range of about 3 mTorr to about 15 mTorr. The ion filter 108 includes an ion guide Q0 that includes four rods (two of which Q0a and Q0b are visible in the figure). An RF voltage source 197 applies RF voltages to the rods of the Q0 ion guide for providing radial confinement of the ions passing therethrough.

The ion filter 108 further includes a plurality of T-shaped auxiliary electrodes such as those discussed above that are interspersed between the rods of the Q0 ion guide such that each of the auxiliary electrodes is interposed between two of the rods, e.g., in a manner discussed above in connection with FIG. 3 above.

A DC voltage source 193a applies a DC voltage to the rods of the Q0 ion guide, where the applied DC voltage generates a DC voltage offset between the Q0 ion guide and the upstream QJet ion guide to accelerate ions exiting the QJet ion guide into the Q0 ion guide. In this embodiment, another DC voltage source 193b applies DC voltages to the auxiliary electrodes in a manner discussed above.

A controller 300 controls the operation of the RF voltage source 197 as well as the DC voltage sources 193a and 193b. In particular, the controller 300 can control the DC voltages applied to the auxiliary electrodes of the ion filter 108, in a manner discussed herein, to compensate substantially for any misalignment of at least one of the auxiliary electrodes and/or the quadrupole rods of the Q0 ion guide.

A mass analyzer Q1 110 receives the ions passing through the ion filter via an ion lens IQ1 and one stubby lens ST1. In this embodiment, the mass analyzer Q1 110 includes four rods that are arranged in a quadrupole configuration and to which RF and/or DC voltages can be applied for selecting ions having m/z ratios within a target range. The ions propagating through the mass analyzer Q1 110 (herein referred to as precursor ions) pass through an ion lens IQ2 and one stubby lenses ST2 to reach a collision cell 112 (q2).

At least a portion of the precursor ions are fragmented in the collision cell 112 to generate a plurality of product ions. The product ions pass through an ion lens IQ3 and a stubby lens ST3 to reach another downstream mass analyzer Q3 114. In this embodiment, the mass analyzer Q3 114 includes four rods that are arranged in a quadrupole configuration and to which RF and/or DC voltages can be applied to allow passage of product ions having an m/z ratio of interest. The product ions passing through the mass analyzer Q3 114 pass through an exit lens 115 to be detected by an ion detector 118. In some embodiments, the quadrupole mass analyzer Q3 114 can be replaced with a time-of-flight (ToF) mass analyzer or any other suitable mass analyzer.

In some embodiments, the controller 300 can be in communication with the ion detector 118 to receive ion detection signals and employ one or more of the received ion detection signals to assess the performance of the mass spectrometer. For example, in some embodiments, a calibrant ion or multiple calibrant ions can be introduced into the mass spectrometer on a predefined temporal schedule and at least one mass signal thereof can be measured to assess the performance of the mass spectrometer. The controller can assess the mass signal and determine whether the performance of the mass spectrometer has degraded below an acceptable level (e.g., by monitoring the intensity of the mass signal). In such a case, the controller can cause the DC voltage source 193a to deliver DC potentials so as to adjust the DC bias voltages applied to the A-pole and/or B-pole of the auxiliary electrodes to improve, and preferably restore, the performance of the mass spectrometer.

As shown schematically in FIG. 5B, in some embodiments, a vacuum chamber 120 is positioned between the orifice plate and the evacuated chamber 121. An ion guide 400 (herein also referred to as DJet™ ion guide) is disposed in the evacuated chamber 120. The ion guide DJet™ includes 12 rods that are arranged in a multipole configuration and to which RF voltages can be applied to provide focusing of the ions received via the orifice of the orifice plate. The evacuated chamber 120 can be maintained at a pressure higher than the pressure at which the vacuum chamber 121 is maintained. An ion lens IQ00 separates the vacuum chamber 120 from the downstream vacuum chamber 121.

A controller for use in controlling RF and/or DC voltages applied to various elements of an ion filter and/or other elements of a mass spectrometer in which an ion filter is incorporated, and particularly for controlling the adjustment of the DC voltages applied to the auxiliary electrodes, can be implemented in hardware, firmware and/or software using known techniques as informed by the present teachings.

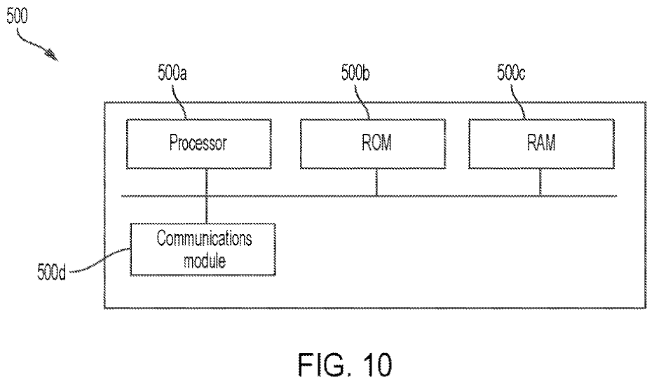

By way of example, FIG. 10 schematically depicts an example of an implementation of such a controller 500, which includes a processor 500a (e.g., a microprocessor), at least one permanent memory module 500b (e.g., ROM), at least one transient memory module (e.g., RAM) 500c, and a bus 500d, among other elements generally known in the art.

The bus 500d allows communication between the processor and various other components of the controller. In this example, the controller 500 can further include a communications module 500e that is configured to allow sending and receiving signals.

Instructions for use by the controller 500, e.g., for adjusting the DC bias voltages applied to the auxiliary electrodes, can be stored in the permanent memory module 500b and can be transferred into the transient memory module 500c during runtime for execution. The controller 500 can also be configured to control the operation of other components of the mass spectrometer, such as the ion guide, and mass analyzer, among others.

Although various aspects of the present teachings were discussed above in connection with a mechanical misalignment of at least one auxiliary electrode and/or at least one multipole rod, the present teachings can also be applied to compensate for an electrical imbalance between voltage sources that apply DC voltages to the auxiliary electrodes and/or the multipole rods.

For example, in some embodiments, the DC voltages applied to the multipole rods (e.g., the quadrupole rods) and/or T-bar electrodes of an ion mass filter may deviate from their nominal values. Such deviation of the voltages applied to the multipole rods and/or the T-bar electrodes may result in trapping of at least some ions within the ion mass filter. In some such embodiments, the voltages applied to the multipole rods and/or the T-bar electrodes can be adjusted so as to reduce, and preferably eliminate, the trapping of ions passing through the ion mass filter. For example, a mass signal associated with a calibrant ion or multiple calibrant ions can be monitored and the DC voltages applied to the quadrupole rods and/or the T-bar electrodes can be adjusted to determine the “sweet spot” for minimized signals loss and thus maximize the mass signal.

The following Examples are provided for further elucidation of various aspects of the present teachings and are not provided to indicate necessarily the optimal ways of practicing the present teachings and/or optimal results that may be obtained.

### EXAMPLES

### Example 1

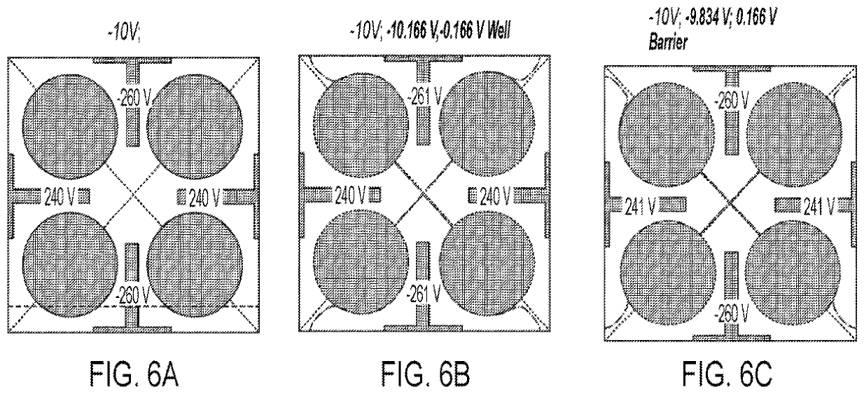

FIGS. 6A, 6B, and 6C depict simulated DC potential traces in an ion filter according to an embodiment, which includes an ion guide having four rods arranged in a quadrupole configuration and four T-shaped auxiliary electrodes, each of which is interposed between two of the quadrupole rods. The DC potential difference between the two pairs of the T-bar electrodes was chosen to be 500 V (with one pair maintained at a DC potential of +240 V and the other pair maintained at −260 V). The DC offset voltage applied to the quadrupole rods was selected to be −10 V. The DC potentials applied to the auxiliary electrodes were shifted by 1 volt between the simulations shown in FIGS. 6A, 6B, and 6C.

FIG. 6A corresponds to an ideal implementation of the ion mass filter in which the quadrupole rods and the T-shaped auxiliary electrodes are precisely aligned and the applied voltages do not deviate from their nominal values. FIG. 6B shows that a deviation of the DC voltages applied to the one pair of T-shaped auxiliary electrodes corresponding to a negative voltage difference of one volt (−1 V, from −260 V to −261 V) (which can simulate misalignment of the T-shaped auxiliary electrodes and/or actual deviation of the applied voltage) results in a potential well with a depth of about −0.166 volts at the entrance of the ion mass filter. FIG. 6C shows that a deviation of the DC voltages applied to the other pair of auxiliary electrodes corresponding to a positive voltage difference of one volt (+1 V, from 240 to 241 V) relative to the ideal case (FIG. 6A) results in a potential barrier with a height of about 0.166 volts.

### Example 2

A mass spectrometer similar to that described above in connection with FIGS. 5A and 5B having both a DJet™ and a QJet™M ion guide was employed to obtain multiple measurements of an MRM transition of polypropylene glycol (PPG) (m/z of 1952) with and without DC bias voltages applied to the T-bar auxiliary electrodes. The following voltages were applied for acquisition of the data presented below (positive ESI):

$$Orifice = - 10 V$$

$$DJet = IQ 00 = QJet = IQ 0 = - 10 V$$

$$Q 0 rod offset = - 10 V$$

$$IQ 1 = - 10.5 V$$

$$ST 1 = - 17.6 V$$

$$Q 1 rod offset = - 11 V$$

$$IQ 2 = - 22.5 V$$

$$ST 2 = - 20. V$$

$$Q 2 rod offset = - 20. V ( collision energy CE = 10 )$$

$$IQ 3 = - 20.5 V$$

$$ST 3 = - 40 V$$

$$Q 3 rod offset = - 21.5 V$$

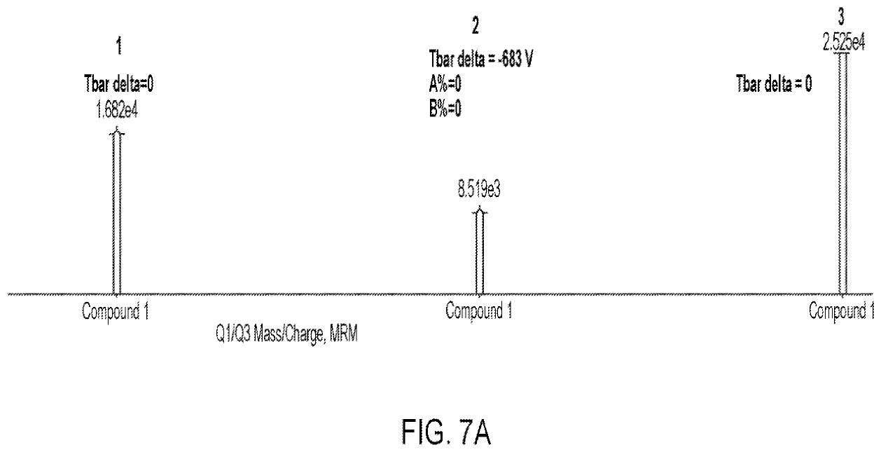

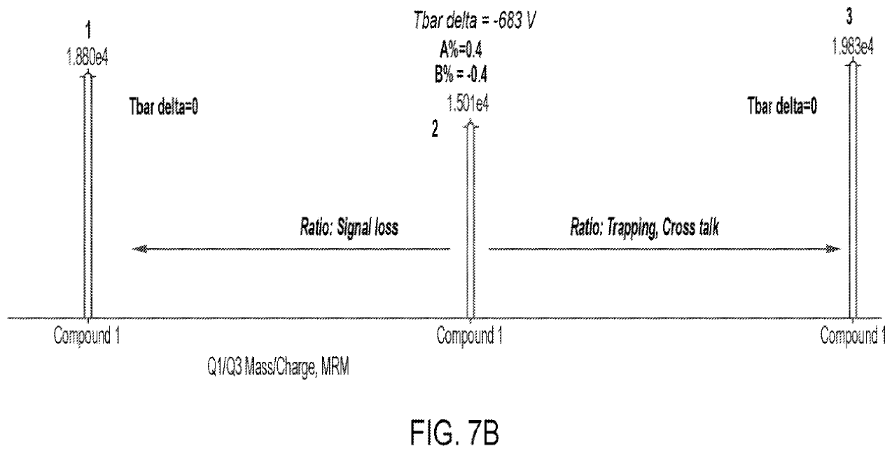

FIG. 7A shows the intensities of three measurements of the MRM transition (with a dwell time of 5 ms) with no DC bias voltages applied to the T-bar auxiliary electrodes (signal 1), with DC potential difference of −683 volts applied between the two pairs of the auxiliary electrodes (signal 2) followed by no DC bias voltages applied to the T-bar electrodes (signal 3). The voltage differential (Tbar delta) applied in 2^{nd} MRM was selected so as to provide a high mass cut-off (HMCO) that was 100 Da higher than precursor ion mass (m/z of 1952 in this example).

The ratio of signal 2 relative to signal 1 is indicative of a 2× loss in signal intensity, e.g., due to misalignment of the auxiliary electrodes and/or the quadrupole rods of the ion filter. Given that HMCO was selected to be greater than 100 Da relative to the precursor mass, this signal loss is greater than the signal loss that would be observed for lower masses as the signal loss due to misalignment is more pronounced for ions with higher masses.

The signal 3 acquired after the DC bias voltages applied to the auxiliary electrodes were switched off shows significant trapping of ions in the ion filter during the period in which the DC voltages were applied to the auxiliary electrodes. In particular, a substantial increase in the intensity of the signal 3 is indicative of the release of the trapped ions and their detection after the application of the DC bias voltages to the auxiliary rods was terminated. Such an effect is herein referred to as “cross-talk” as it relates to ions during one MRM measurement being trapped and then detected during a subsequent MRM measurement.

Subsequently, the DC voltages applied to the auxiliary electrodes were manually adjusted and performance of the mass spectrometer was monitored. Through such monitoring and adjustment of the DC voltages applied to the auxiliary electrodes, it was determined that a slight imbalance in the voltages applied to the A and B poles of the auxiliary electrodes (i.e., preliminary results of +0.4% on A and −0.4% on B corresponding to a Delta(A−B)=0.8%) can optimize the performance of the mass spectrometer, as evidenced by the data presented in FIG. 7B, which was obtained similarly to the data presented in FIG. 7A. The DC voltage applied to A pole can be defined as Tbar DC A=Q0 rod offset+(1−A %)×(initial Tbar offset+(initial Tbar delta/2)) and Tbar DC B=Q0 rod offset+(1−B %)×(initial Tbar offset+(initial Tbar−delta/2)), where Tbar delta refers to the DC voltage difference applied between the A-pole and the B-pole of the auxiliary electrodes.

In particular, FIG. 7B shows that the intensity of the MRM transition with the unbalanced DC voltages applied to the auxiliary electrodes is significantly greater than the respective intensity of the MRM transition shown in FIG. 7A and the intensity of the MRM transition acquired after the application of DC bias voltages to the auxiliary electrodes was terminated was lower than the intensity of the respective MRM measurement presented in FIG. 7A. With the adjustments, the intensity ratios between second to first MRMs or between second to third MRMs are closer to 1. The significant reduction in the signal loss and cross talk indicates that the unbalancing of the DC voltages applied to the auxiliary electrodes has significantly reduced trapping of the ions in the ion filter.

### Example 3

A series of measurements of an MRM transition of a standard MS tuning solution were performed, to investigate the Tbar DC tuning using ions of m/z 1522. Under initial conditions, DC voltages were applied to the A and B poles of the auxiliary electrode so as to generate a potential difference of −525 V between the A pole and the B pole. The DC voltage applied to the A pole=−10 V (corresponding to the DC offset voltage applied to the quadrupole rods)+(−525/2)=272.5 V) and the DC voltage applied to the B pole=−10 V−(−525/2)=252.5 V. Under these conditions, a signal loss of about 2× was observed.

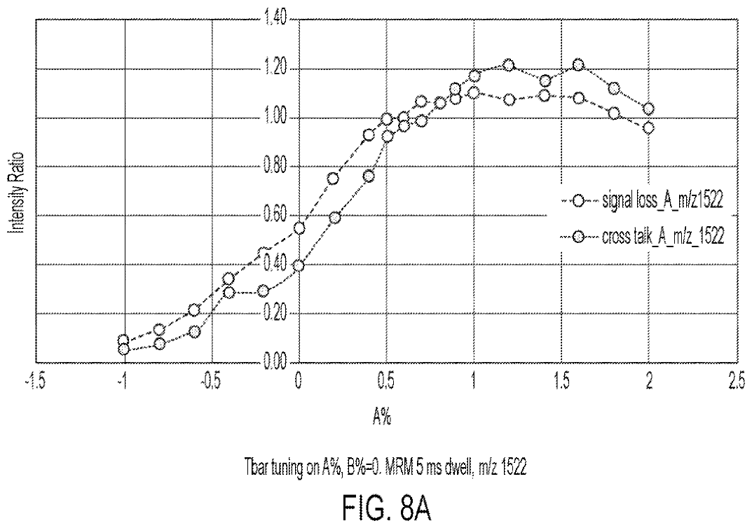

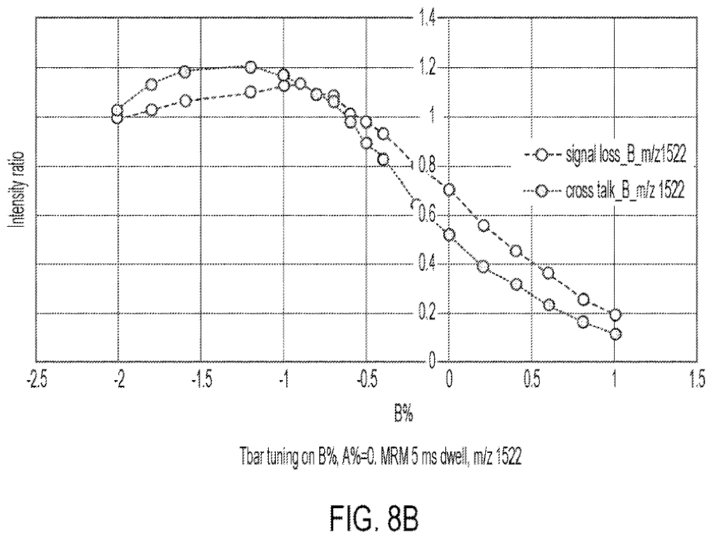

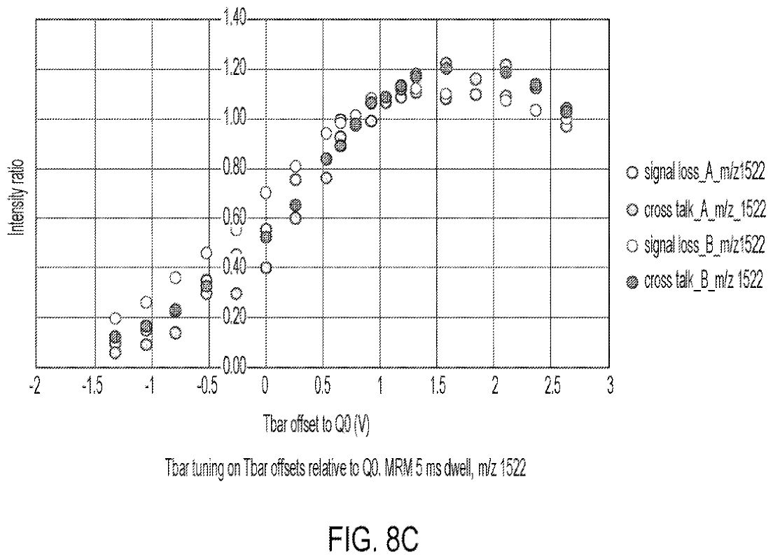

FIG. 8A shows the tuning results in terms of the MRM signal intensity loss and cross talk when the DC voltage applied to the B pole of the auxiliary electrodes was fixed and the DC voltage applied to the A pole was tuned. FIG. 8B shows the tuning results in terms of the MRM signal intensity loss and cross talk when the DC voltage applied to the A pole was fixed and the DC voltage applied to the B pole was tuned. And FIG. 8C shows the tuning results in terms of the MRM signal intensity loss and cross talk when T-bar offset voltage relative to Q0 was tuned.

The above data indicates that a relatively wide tuning “sweet spot” can be observed when tuning for m/z 1522. When tuning for MRMs with 6 ions of the MS tuning solution, it was observed that the optimized spot was narrowed to a delta (A %−B%)=0.9 to 1, which is equivalent to a T-bar offset set of 1.2 to 1.3 V relative to Q0 for m/z 1522. This is equivalent to −0.23% to −0.25% of Tbar delta voltage applied in this test.

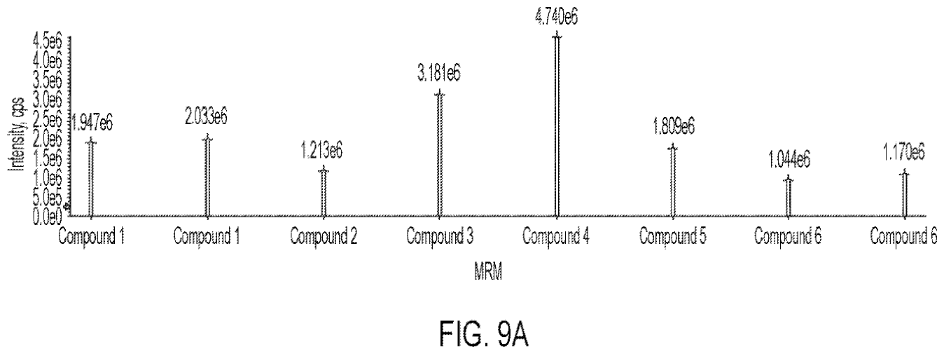

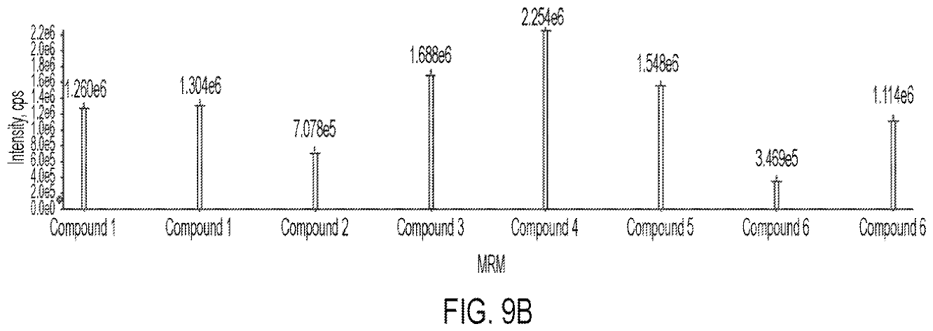

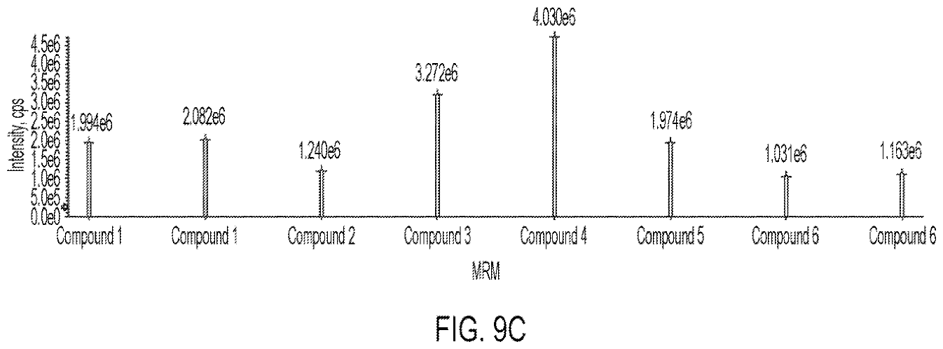

FIGS. 9A and 9C show the intensities of MRM transitions of the 6 ions obtained with ion filtering applied in pole A (FIG. 9A) and pole B (FIG. 9C) under optimized tuning conditions for each pole, i.e., pole A, A%=0, B%=0; pole B, A%=0.9%, B%=0, as listed in Tables 2 and 4. In contrast, FIG. 9B shows the respective MRM transitions of those ions with no DC correction applied to Pole B (See, Table 3). Substantial loss of signals were shown with no tuning or correction.

TABLE 2

| Compound | Q1 mass | Tbar delta (V) | Shift on A % |
|---|---|---|---|
| 1 | 266.1 | 0 | 0 |
| 1 | 266.1 | 67 | 0 |
| 2 | 442.2 | 132 | 0 |
| 3 | 609.3 | 195 | 0 |
| 4 | 829.5 | 278 | 0 |
| 5 | 922.0 | 312 | 0 |
| 6 | 1522.0 | 537 | 0 |
| 6 | 1522.0 | 0 | 0 |

TABLE 3

| Compound | Q1 mass | Tbar delta (V) | Shift on A % |
|---|---|---|---|
| 1 | 266.1 | 0 | 0 |
| 1 | 266.1 | −67 | 0 |
| 2 | 442.2 | −132 | 0 |
| 3 | 609.3 | −195 | 0 |
| 4 | 829.5 | −278 | 0 |
| 5 | 922.0 | −312 | 0 |
| 6 | 1522.0 | −537 | 0 |
| 6 | 1522.0 | 0 | 0 |

TABLE 4

| Compound | Q1 mass | Tbar delta (V) | Shift on A % |
|---|---|---|---|
| 1 | 266.1 | 0 | 0.9 |
| 1 | 266.1 | −67 | 0.9 |
| 2 | 442.2 | −132 | 0.9 |
| 3 | 609.3 | −195 | 0.9 |
| 4 | 829.5 | −278 | 0.9 |
| 5 | 922.0 | −312 | 0.9 |
| 6 | 1522.0 | −537 | 0.9 |
| 6 | 1522.0 | 0 | 0.9 |

While the above data was obtained via manual tuning, in some embodiments, the tuning of the DC voltage applied to the A pole, the B pole or tuning of a DC offset voltage relative to rods can be automated so as to obtain optimal values or value ranges of these DC voltages, e.g., via monitoring signal intensity loss and/or cross talk, associated with one or more MRM transitions of one or more precursor ions, to compensate any possible misalignment.

Although some aspects have been described in the context of a system and/or an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a processor, a microprocessor, a programmable computer or an electronic circuit. In some embodiments, some one or more of the most important method steps may be executed by such an apparatus.

Depending on certain implementation requirements, embodiments of the invention can be implemented in hardware and/or in software. The implementation can be performed using a non-transitory storage medium such as a digital storage medium, for example a floppy disc, a DVD, a Blu-Ray, a CD, a ROM, a PROM, and EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Those having ordinary skill will appreciate that various changes can be made to the above embodiments without departing from the scope of the invention.

What is claimed is:

1. An ion filter for use in a mass spectrometer, comprising:
a plurality of rods arranged in a multipole configuration to provide a passageway through which ions can travel, said plurality of rods being configured for application of RF voltages thereto to provide an electromagnetic field within said passageway for providing radial confinement of the ions and further configured for application of a DC voltage thereto,
at least two pairs of auxiliary electrodes interspersed between said plurality of rods and configured for application of a DC bias voltages said electrodes,
wherein the DC bias voltage applied to each pair comprises a DC filtering component and a DC corrective component, wherein a polarity of a DC filtering component applied to one pair of the auxiliary electrodes is opposite to a polarity of a DC filtering component applied to the other pair of the auxiliary electrodes, and wherein the DC filtering components of the voltages applied to said two pairs of auxiliary electrodes are configured to provide stable trajectories for ions with m/z ratios in a target range and unstable trajectories for ions with m/z ratios outside said target range and the DC corrective components are configured to provide a substantial compensation for misalignment of at least one of said plurality of rods and said auxiliary electrodes relative to at least another one of said plurality of rods and said auxiliary electrodes.

2. The ion filter of Claim 1, wherein said DC corrective components are configured to minimize trapping of the ions with m/z ratios in said target range within said passageway.

3. The ion filter of Claim 1, wherein said misalignment comprises any of an axial and a radial misalignment.

4. The ion filter of Claim 1, wherein each of said DC corrective components is in a range of about −5% to about +5% of a respective DC filtering component.

5. The ion filter of Claim 1, wherein said RF voltages are configured to filter ions having m/z ratios less than a first m/z threshold.

6. The ion filter of Claim 5, wherein said DC bias voltages applied to the auxiliary electrodes and said voltage applied to said plurality of rods are configured to generate an electric field distribution within said passageway configured to cause filtering of ions having m/z ratios above a second threshold. thereby providing a bandpass ion filter allowing passage of ions with m/z ratios between said first and said second threshold.

7. The ion filter of Claim 1, wherein said auxiliary electrodes comprise a plurality of T-shaped electrodes.

8. The ion filter of Claim 7, wherein said T-shaped electrodes comprise a backplate and a stem extending radially from said backplate.

9. The ion filter of Claim 1, wherein said plurality of rods comprise four rods arranged in a quadrupole configuration.

10. The ion filter of Claim 9, wherein said at least two pairs of auxiliary electrodes comprises four auxiliary electrodes each of which is positioned between two of said plurality of rods.

11. The ion filter of Claim 1, wherein said RF voltages have a frequency in a range of about 0.1 MHz to about 5 MHz.

12. The ion filter of Claim 11, wherein said RF voltages have an amplitude in a range of about 10 V to about 5 kV (V₀₋ₚ).

13. The ion filter of Claim 12, wherein said DC bias voltages applied to said auxiliary electrodes have an amplitude in a range of about −8.5 kV to about +8.5 kV.

14. A mass spectrometer, comprising:
an ion filter comprising:
a plurality of rods arranged in a multipole configuration to provide a passageway through which ions can travel, said plurality of rods being configured for application of RF voltages thereto to provide an electromagnetic field within said passageway for providing radial confinement of the ions and further configured for application of a DC voltage thereto,
at least two pairs of auxiliary electrodes interspersed between said plurality of rods and configured for application of a DC bias voltage with one polarity to one of said pairs and a DC bias voltage with an opposite polarity to the other one of said pairs to provide a DC voltage difference between said auxiliary electrodes and said plurality of rods,
wherein the DC bias voltage applied to each pair comprises a DC filtering component and a DC corrective component, wherein the DC filtering components of the voltages applied to said two pairs of auxiliary electrodes are configured to provide stable trajectories for ions with m/z ratios in a target range and unstable trajectories for ions with m/z ratios outside said target range and the DC corrective components are configured to provide a substantial compensation for misalignment of at least one of said plurality of rods and said auxiliary electrodes relative to at least another one of said plurality of rods and said auxiliary electrodes.

15. The mass spectrometer of claim 14, further comprising at least one RF voltage source for applying said RF voltages to said plurality of rods.

16. The mass spectrometer of claim 15, further comprising at least one DC voltage source for applying said DC voltages to said plurality of rods and said auxiliary electrodes.

17. The mass spectrometer of claim 16, wherein said at least one DC voltage source comprises a first DC voltage source for applying said DC voltage to said plurality of rods and a second DC voltage source for applying said DC bias voltages to said auxiliary electrodes.

18. A method for tuning an ion filter incorporated in an MS/MS mass spectrometer, wherein said ion filter comprises a plurality of rods arranged in a multipole configuration to provide a passageway for transit of ions and configured for application of RF voltages thereto and at least two pairs of auxiliary electrodes dispersed between said rods and configured for application of a DC bias voltage with one polarity to one of said pairs of the auxiliary electrodes and a DC bias voltage with an opposite polarity to the other of said pairs of the auxiliary electrodes, wherein said DC and RF voltages are selected to generate an electromagnetic field distribution within said passageway configured to allow passage of ions having m/z ratios within a target range and to inhibit passage of ions having m/z ratios outside said target range, said method comprising:
(a) using said MS/MS mass spectrometer to acquire a first measurement of an MRM transition of a precursor ion with no DC bias voltages applied to said auxiliary electrodes,
(b) using said MS/MS mass spectrometer to acquire a second measurement of said MRM transition of the precursor ion with DC voltages applied to said auxiliary electrodes to provide a target ion transmission bandwidth,
(c) estimating a signal loss associated with said ion filter based on a ratio of said second measurement relative to said first measurement,
(d) adjusting said DC voltages applied to said auxiliary electrodes to reduce said signal loss, and
(e) iterating said steps (a)-(d) so as to minimize said signal loss.

19. The method of Claim 18, further comprising performing a third measurement of the MRM transition, subsequent to said second measurement.

20. The method of Claim 19, further comprising computing a ratio of the intensity of said third MRM transition measurement to an intensity of said second MRM measurement to estimate a cross talk between said second and said third MRM measurements.
